(19) United States
(12) Patent Application Publication
(10) Pub. No.: US 2014/0201661 A1
(43) Pub. Date: Jul. 17, 2014

(54) METHOD AND SYSTEM FOR PROVIDING A TWISTY USER INTERFACE ELEMENT

(71) Applicant: International Business Machines Corporation, Armonk, NY (US)

(72) Inventors: Corville O. Allen, Morrisville, NC (US); Albert A. Chung, Cary, NC (US); Monica Senior, College Park, GA (US); Kam K. Yee, Apex, NC (US)

(73) Assignee: International Business Machines Corporation, Armonk, NY (US)

(21) Appl. No.: 14/079,045

(22) Filed: Nov. 13, 2013

Related U.S. Application Data
(63) Continuation of application No. 13/739,066, filed on Jan. 11, 2013.

(51) Int. Cl. G06F 3/0484; G06F 3/0486; G06F 3/0481

(52) U.S. Cl. CPC G06F 3/04847; G06F 3/0481; G06F 3/0486
USPC 715/769; 715/800

(57) ABSTRACT

A method and system for providing an adjustable user interface (UI) element comprises displaying as part of a UI of an application window a UI control element that controls a variably-sized content section. Responsive to receiving a variable adjustment made to the UI control element by a user, the variably-sized content section is resized in proportion to an amount of the variable adjustment received.

### CROSS-REFERENCE TO RELATED APPLICATIONS

This application is a Continuation of patent application Ser. No. 13/739,066, filed Jan. 11, 2013, assigned to the assignee of the present application, and incorporated herein by reference.

### BACKGROUND

Today, an increasing number of e-mail and document applications include or support collapsible sections within the application or a document. Each collapsible section includes a user interface (UI) element, which when clicked by the user, expands the section to reveal more content and clicking the UI element again collapses the section and hides the content. The UI element may be a symbol, such as a rotating arrow or +/− indicator; or a word, such as “more”, or “details”. Typically, such a UI element is referred to as a “twisty”, since the UI element commonly rotates between a horizontal position and a vertical position when clicked to indicate open and closed states, respectively.

While a twisty is a useful user interface element in general, a conventional twisty only has two discrete states, open and closed, which in some applications, may hinder the user's interaction with the application.

As an example, consider email applications, such as Lotus Notes™ and Microsoft Outlook™ where email folders may be arranged using twisties. In Lotus Notes for example, there may be four twisty sections for “High Importance”, “Calendar Events”, “Normal” and “Probable Spam” emails. Assuming a large amount of emails are received daily, the user may have the “Normal” email section in the open state and the other three twisty sections in closed state so that the user can view new incoming normal emails. Otherwise, if all four sections are in the open state, then the user would have to scroll up and down the Lotus Notes window to view the emails in the four different sections. It can be seen that in either case, the user must manually open the close the twisty sections to view/side hidden emails or else scroll up and down the window to manually find new incoming emails in the different twisty sections.

Accordingly, it would be desirable to provide an improved method and system for providing a twisty user interface element.

### BRIEF SUMMARY

The exemplary embodiment provides methods and systems for providing an adjustable user interface (UI) element. Aspects of exemplary embodiment include displaying as part of a UI of an application window a UI control element that controls a variably-sized content section. Responsive to receiving a variable adjustment made to the UI control element by a user, the variably-sized content section is resized in proportion to an amount of the variable adjustment received.

According to the method and system disclosed herein, the exemplary embodiment enables a user to variably control how much content is displayed by making variable adjustments to the UI control element.

### BRIEF DESCRIPTION OF SEVERAL VIEWS OF THE DRAWINGS

FIG. 1 is a diagram illustrating one embodiment of a system for providing a twisty user interface element.

FIG. 2 is a block diagram illustrating a process for providing an adjustable UI element for variable display of hidden content in accordance with an exemplary embodiment.

FIG. 3 is a diagram illustrating an embodiment where the UI control element comprises an adjustable twisty.

FIG. 4 is a block diagram illustrating a further aspect of the exemplary embodiments in which a plurality of adjustable twisties are displayed in a single application window.

### DETAILED DESCRIPTION

The exemplary embodiment relates to methods and systems for providing a twisty user interface element. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

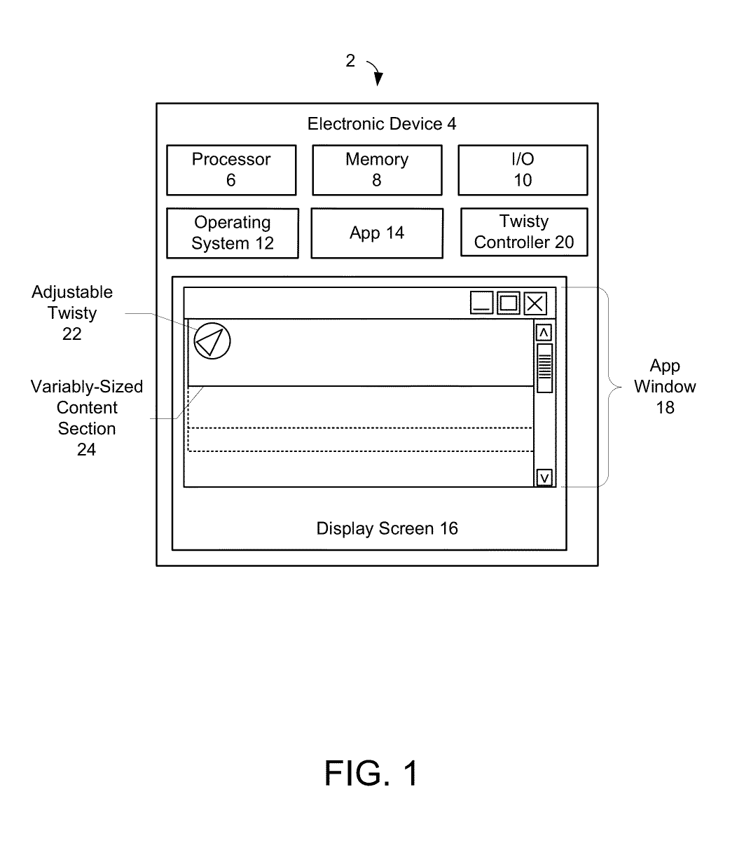

FIG. 1 is a block diagram illustrating an exemplary system environment in which one embodiment for providing a twisty user interface element may be implemented. The system 2 includes an electronic device 4 having at least one processor 6, a memory 8, input/output (I/O) 10, an operating system 12, at least one application (app) 14, and a display screen 16. The processor 6, memory 8 and I/O 10 may be coupled together via a system bus (not shown). The OS 12 and the app 14 reside in memory and are executed by the processor 6. When running, the app 14 may display an application window 18 on the display screen 16.

If so configured, the application 14 may support display of collapsible/expandable contents sections within the application or a document using a user interface (UI) control element referred to as a twisty. As described above, one problem with the conventional twisty is that the twisty has two discrete states, open or closed, which may be inconvenient for the user.

According to an exemplary embodiment, the electronic device 4 is provided with a twisty controller 20 that displays a progressive UI control element, referred to herein as an adjustable twisty 22, that controls a variably-sized content section 24. In one embodiment, adjustable twisty 22 may be moved or variably adjusted by the user to any one of a range of adjustment settings. The twisty controller 20 may then expand or collapse the content section 24 in proportion to the amount of user adjustment.

More specifically, the twisty controller 20 configures the adjustable twisty 22 and the variably-size content section 24 for adjustable size behavior and communicates this capability to the app 14. The app 14 feeds a list of content to display to the twisty controller 20. The twisty controller 20 adjusts the size of the variably-sized content section 24 based on the current adjustment level of the adjustable twisty 22 and displays the content in the variably-sized content section 24.

The benefit of the adjustable twisty 22 is increased usability and quick access to features from a single UI element. As electronic devices become smaller and have less screen space, the exemplary embodiments provide users with an easier way to manage the display of content.

In one embodiment, the twisty controller 20 comprises a software component. Although the twisty controller 20 is shown as a single component, it should be understood that the functions of the twisty controller 20 may be implemented using a different number of software components. In addition, the twisty controller 20 may be implemented as part of the application 14, as a separate application, or as part of the operating system 12.

The electronic device 4 may be implemented as any type of computing device that displays content in application windows including, a smart or mobile phone, a tablet computer, a personal computer (e.g., desktop, laptop, or notebook), a game system, and the like. The electronic device 4 may include hardware components of typical computing devices, including input devices, such as, a keyboard, pointing device, a microphone, and buttons (not shown), and output devices, such as speakers, and the like (not shown). The memory 8 may comprise various types of computer-readable media, e.g., flash memory, hard drive, optical disk drive, magnetic disk drive, and the like, containing computer instructions that implement the functionality disclosed when executed by the processor. The electronic device 4 may further include wired or wireless network communication interfaces for communication.

The processor 6 may be part of data processing system suitable for storing and/or executing software code, which may comprise an operating system 12 and various applications. The processor 6 may be coupled directly or indirectly to elements of the memory 8 through a system bus (not shown). The memory elements can include local memory employed during actual execution of the program code, bulk storage, and cache memories which provide temporary storage of at least some program code in order to reduce the number of times code must be retrieved from bulk storage during execution.

The input/output 10 or I/O devices can be coupled to the system either directly or through intervening I/O controllers. Network adapters (not shown) may also be coupled to the system to enable the data processing system to become coupled to other data processing systems or remote printers or storage devices through intervening private or public networks. Modems, cable modems and Ethernet cards are just a few of the currently available types of network adapters.

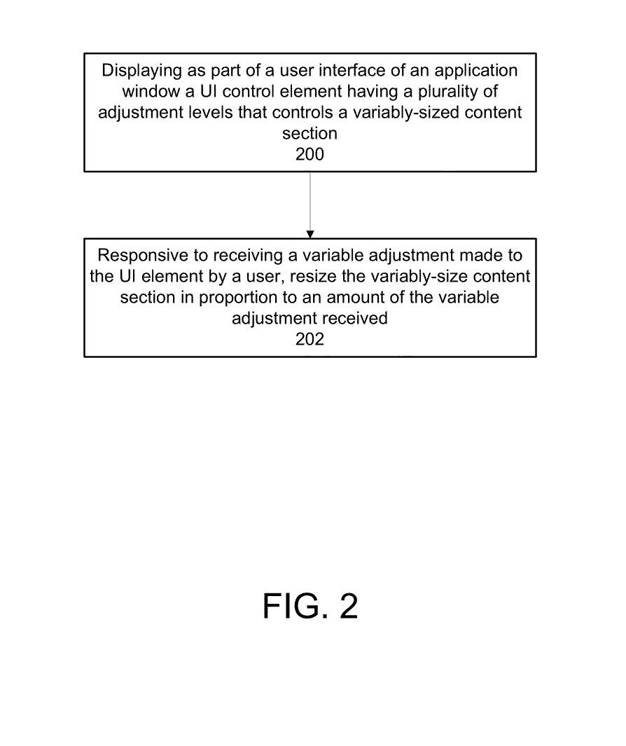

FIG. 2 is a block diagram illustrating a process for providing an adjustable UI element for variable display of hidden content in accordance with an exemplary embodiment. In one embodiment process is performed by a software component, such as the twisty controller 20. In an alternative embodiment the process may be performed by any combination of the twisty controller, the application 14, and the operating system 12.

The process may begin by displaying as part of a user interface of an application window a UI control element having a plurality of adjustment levels that controls a variably-sized content section (block 200). Responsive to the twisty controller 20 receiving a variable adjustment made to the UI control element by a user, the twisty controller 20 resizes the variably-sized content section in proportion to an amount of the variable adjustment received (block 202).

Although in a preferred embodiment the UI control element comprises an adjustable twisty 22, the term adjustable twisty 22 is intended to include any type of adjustable UI element, including, but not limited to, a rotating arrow, a dial and a slider.

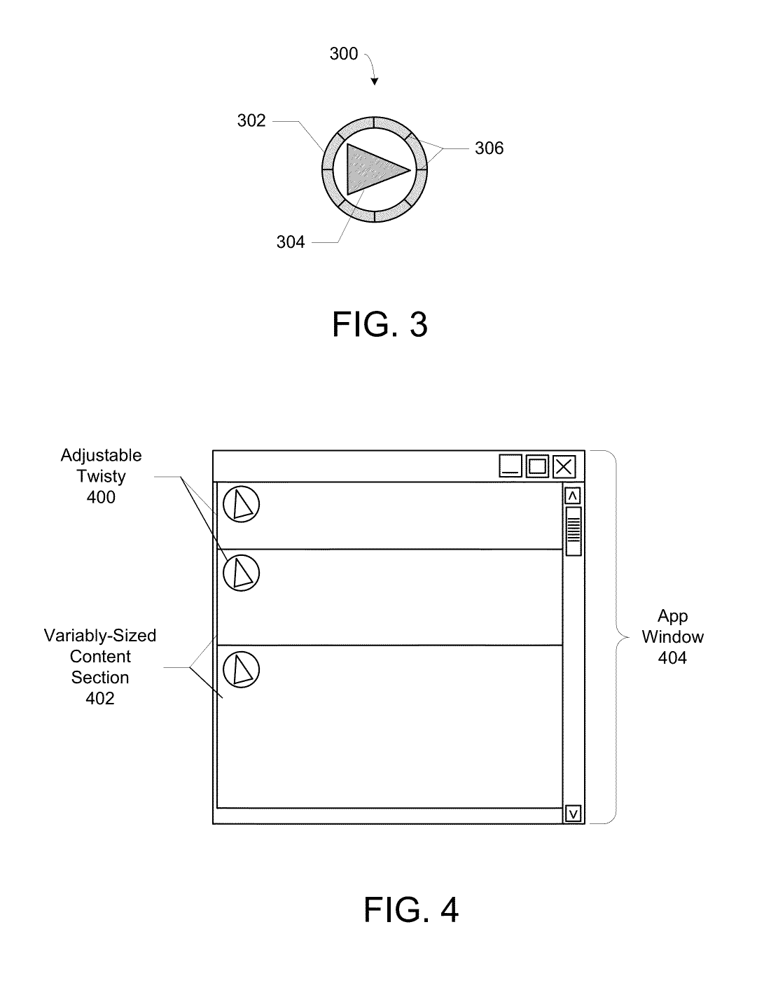

FIG. 3 is a diagram illustrating an embodiment where the UI control element comprises an adjustable twisty 300 implemented as a dial 302 encircling a twisty arrow 304. The size of the content section (not shown) varies in proportion to the amount the twisty arrow 304 is moved around the dial 302. For example, assume the default position for the twisty arrow 304 is zero degrees on the dial 302 indicating a closed content section. Rotating the twisty arrow 304 clockwise to 90° on the dial 302, as shown, would expand the corresponding content section to 25%. Conversely, rotating the twisty arrow 304 counter-clockwise some distance on the dial 302 would collapse the content section proportionally to, or as a function of, that distance.

In one embodiment, the dial 302 may include a plurality of adjustments levels (shown as lines) 306 on the dial 302. The twisty controller 20 allows the user to move the twisty arrow 304 to any one of the adjustment levels 306 to control the amount of content displayed in the variably-sized content section 24. The adjustable twisty 300 is shown with eight adjustment levels, 306 providing eight possible sizes for the content section.

Although FIG. 3 shows the adjustable twisty 300 implemented as a round dial, the adjustable twisty 300 may be displayed as any polygon shape with or without adjustment level indicators. For example, the adjustable twisty 300 could be implemented as a rectangular slider, for instance.

In one embodiment, the twisty controller 20 may receive the variable adjustment made to the twisty arrow 304 in response to the user clicking and dragging the twisty arrow. In another embodiment, the twisty controller 20 may receive the variable adjustment made to the twisty arrow 304 in response to the user clicking on a selected adjustment level 306 or an area between two of the adjustment levels 306, causing the twisty arrow 304 to automatically move to the selected adjustment level 306.

According to a further aspect of the exemplary embodiment, settings of the adjustable twisty 300 may be user configurable. In one embodiment, a setting for the starting point of the twisty arrow 304 may be configured by the user. In a second embodiment, the user may also set a preconfigured size for the variable-sized content section 24. In a further embodiment, the user may configure the adjustable twisty 300 to automatically expand the variably-sized content section 24 as new content is received until the variably-sized content section 24 reaches the preconfigured size.

According to a third embodiment, the adjustable twisty may be configured to automatically display the variably-sized content section 24 at the preconfigured size when the twisty arrow is set to an open position and to automatically expand/contract the size of the variably-sized content section 24 as content is received, deleted and moved.

FIG. 4 is a block diagram illustrating a further aspect of the exemplary embodiments in which a plurality of adjustable twisties are displayed in a single application window. In this embodiment, two or more adjustable twisties 400 and corresponding variably-sized content sections 402 may be displayed within the application window 404, where a proportion of the application window 404 is assigned to each of the adjustable twisties 400 and corresponding variably-sized content sections 402.

For example, assuming the application window 404 is for an email application, then the first adjustable twisty that displays high important items may be assigned 20% of the application window 404, a second adjustable twisty that displays calendar entries may be assigned 30% of the application window 404, and a third adjustable twisty that displays normal emails may be assigned 50% of the application window.

In one embodiment, the proportions of the application window 404 assigned to the adjustable twisties 400 may not be changed. For example, even if each adjustable twisty 400 is set a wide open position, the variably-sized content sections 402 cannot exceed the proportion of the application window 404 assigned to the corresponding adjustments with 400. The proportion the application window assigned to each of the adjustable twisties 400 may be reduced, however, by the user making adjustments to the adjustable twisties 400 that collapse the variably-sized content sections 402.

In another embodiment, the proportions of the application window 404 assigned to the adjustable twisties 400 may be adjustable based on the variable adjustments made to the adjustable twisties 400 by the user, where the changes are accumulated and used to recalculate the proportions assigned to each adjustable twisty in real-time. In the example above, if the first adjustable twisty 400 is set to a closed position, then the 20% of the application window 404 assigned to the first adjustable twisty 400 may be used by the second adjustable twisty to expand the proportion of its variably-sized content section 402 from 30% to 50%.

In one embodiment, the user may configure the proportions of the application window 404 assigned to each of the adjustable twisties 400, while in another embodiment the proportions are automatically assigned. In another embodiment, the user may make the proportions assigned to the adjustable twisties 400 fixed for one or more of the adjustable twisties 400. In one embodiment, a configuration window may be reached by the user right clicking on one of the adjustable twisties to bring up a menu of options.

In yet another embodiment, the proportions of the application window 404 assigned to the adjustable twisties 400 may be adjustable based on the type of content displayed in the corresponding content sections. For example, newly arrived email entries may cause a previously closed content section to expand to allow the user to view newly-arrived email entries. In one embodiment, the user may configure the maximum amount of automatic expansion.

A method and system for providing a twisty user interface element has been disclosed. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for providing an adjustable user interface (UI) element, the method performed by at least one software component executing on at least one processor, comprising:
displaying as part of a UI of an application window a UI control element that controls a variably-sized content section; and
responsive to receiving a variable adjustment made to the UI control element by a user, resizing the variably-sized content section in proportion to an amount of the variable adjustment received.

2. The method of claim 1, further comprising: displaying the UI control element as an adjustable twisty comprising at least one of a rotating arrow, a dial, and a slider.

3. The method of claim 1, further comprising: displaying the UI control element with a plurality of adjustment levels, and allowing the user to position the UI control element on any one of the plurality of adjustment levels.

4. The method of claim 1, further comprising: receiving the variable adjustment in response to the user clicking and dragging the UI control element.

5. The method of claim 1, further comprising receiving the variable adjustment in response to the user clicking on a selected adjustment level or an area between two adjustment levels.

6. The method of claim 1, further comprising: automatically expanding the variably-sized content section as new content is received until the variably-sized content section reaches a preconfigured size.

7. The method of claim 4, further comprising: automatically displaying the variably-sized content section at a preconfigured size when the UI control element is set to an open position and automatically expanding/contracting the size of the variably-sized content section as content is received, deleted and moved.

8. The method of claim 1, further comprising displaying a plurality of UI control elements in the application window wherein a proportion of the application window is assigned to each of the plurality of UI control elements and corresponding variably-sized content sections.

9. The method of claim 8, further comprising adjusting the proportions of the application window assigned to the UI control elements based on the variable adjustments made to the UI control elements by the user, where the changes are accumulated and used to recalculate the proportions assigned to each of the UI control elements in real-time.

10. The method of claim 8, wherein the proportions of the application window assigned to the UI control elements are adjustable based on a type of content displayed in the corresponding content sections.

11. An executable software product stored on a computer-readable medium containing program instructions for an adjustable user interface (UI) element, the program instructions for:
displaying as part of a UI of an application window a UI control element that controls a variably-sized content section; and
responsive to receiving a variable adjustment made to the UI control element by a user, resizing the variably-sized content section in proportion to an amount of the variable adjustment received.

12. The executable software product of claim 11, further comprising program instructions for: displaying the UI control element as an adjustable twisty comprising at least one of a rotating arrow, a dial, and a slider.

13. The executable software product of claim 11, further comprising program instructions for: displaying the UI control element with a plurality of adjustment levels, and allowing the user to position the UI control element on any one of the plurality of adjustment levels.

14. The executable software product of claim 11, further comprising program instructions for: receiving the variable adjustment in response to the user clicking and dragging the UI control element.

15. The executable software product of claim 11, further comprising program instructions for receiving the variable adjustment in response to the user clicking on a selected adjustment level or an area between two adjustment levels.

16. The executable software product of claim 11, further comprising program instructions for: automatically expanding the variably-sized content section as new content is received until the variably-sized content section reaches a preconfigured size.

17. The executable software product of claim 16, further comprising program instructions for: automatically displaying the variably-sized content section at a predetermined size when the UI control element is set to an open position and automatically expanding/contracting the size of the variably-sized content section as content is received, deleted and moved.

18. The executable software product of claim 11, further comprising program instructions for displaying a plurality of UI control elements in the application window wherein a proportion of the application window is assigned to each of the plurality of UI control elements and corresponding variably-sized content sections.

19. The executable software product of claim 18, further comprising program instructions for adjusting the proportions of the application window assigned to the UI control elements based on the variable adjustments made to the UI control elements by the user, where the changes are accumulated and used to recalculate the proportions assigned to each of the UI control elements in real-time.

20. The executable software product of claim 18, wherein the proportions of the application window assigned to the UI control elements are adjustable based on a type of content displayed in the corresponding content sections.
